(19) United States
(12) Patent Application Publication
(10) Pub. No.: US 2012/0077358 A1
(43) Pub. Date: Mar. 29, 2012

(54) CARD CONNECTOR, WIRING BOARD UNIT, AND ELECTRONIC DEVICE

(75) Inventor: Koji ISHIKAWA, Kawasaki (JP)

(73) Assignee: FUJITSU LIMITED, Kawasaki-shi (JP)

(21) Appl. No.: 13/232,702

(22) Filed: Sep. 14, 2011

(30) Foreign Application Priority Data
Sep. 27, 2010 (JP) 2010-215284

(51) Int. Cl. H01R 13/62; H01R 12/00

(52) U.S. Cl. 439/65; 439/152

(57) ABSTRACT

A card connector includes a housing and a card tray configured to be drawn out of the housing. The card tray includes a first protrusion configured to define a movement path of the card tray, and a second protrusion configured to restrict a movement the card tray. The housing includes an inclined portion extending in a drawing direction of the card tray to guide the first protrusion.

### CROSS-REFERENCE TO RELATED APPLICATION

This application is based upon and claims the benefit of priority of Japanese Patent Application No. 2010-215284, filed on Sep. 27, 2010, the entire contents of which are incorporated herein by reference.

### FIELD

The embodiments discussed herein relate to a card connector, a wiring board unit including a card connector, and an electronic device including a card connector.

### BACKGROUND

Hitherto, SIM (Subscriber Identity Module) cards have been used for mobile electronic devices such as cellular phone devices. A SIM card includes a unique identification number that specifies a telephone number of a cellular phone to enable communication by tying the device to the telephone number. In recent years, users often replace the SIM card in the mobile electronic device such as a cellular phone in response to getting a new cellular phone.

A card connector 100 provided with a drawer tray as illustrated in FIG. 4 is occasionally used for the SIM card. FIG. 5 illustrates the card connector 100 provided on a wiring board taken out of a cellular phone device. FIG. 6 is an exploded perspective view of the card connector 100.

As illustrated in FIG. 6, the card connector 100 mainly includes a housing 102 and a tray 104. The housing 102 is provided with a connection terminal connected to an electronic component, and accommodates a SIM card 103 to connect the SIM card 103 to the electronic component. The tray 104 is movable to be drawn out of the housing 102 with the SIM card 103 mounted on the tray 104.

FIGS. 7A to 7C schematically illustrate how the SIM card 103 accommodated in the card connector 100 is replaced.

First, the card connector 100 is provided on a wiring board 106 as illustrated in FIG. 7A. The user picks a tray lug portion 108, which is provided on a closer side of the tray 104 of the card connector 100, with his/her finger or fingernail to draw out the tray 104 as illustrated in FIG. 7B. With the tray 104 completely drawn out, the SIM card 103 on the tray 104 is taken out. A notched portion 110 is provided in a portion of the tray 104 to allow the SIM card 103 to be easily taken out. Because the gap between the tray 104 thus taken out and the wiring board 106 is very narrow, however, it is difficult to take the SIM card 103 out of the tray 104 while supporting the lower surface of the SIM card 103 with a finger. Because it is difficult to take out the SIM card 103, the tray 104 is occasionally taken out excessively or extracted from the housing 102, which may damage the tray 104 or the housing 102.

Hitherto, techniques for inclining a tray of an electronic device such that a side of the tray in the drawing direction is positioned to be higher than a farther side of the tray when the tray is drawn out to draw out what is accommodated in the tray, such as a card, have been known.

For example, a mechanism for a disk device that performs at least one of playback of information recorded on a disk accommodated in a cartridge and recording of information onto the disk is known.

That is, when a tray is moved to a disk mounting position, lift lever moving means moves a lift lever to a lift position. Thus, in this state, when the cartridge is mounted on a cartridge mounting surface, an end portion of the cartridge in the ejecting direction is lifted up with respect to the tray with reference to an end portion of the cartridge in the retracting direction.

A mechanism for a disk device that lifts up the front portion of a disk when a disk tray is drawn out of the main body of the device to allow the disk to be easily taken is also known. In the disk device, a T-shaped rotary member positioned under the disk is rotated to lift up one end of the disk.
[Patent Document 1] PCT International Publication No. WO 2007/066735
[Patent Document 2] Japanese Patent Laid-open Publication No. 2005-004831.

### SUMMARY

According to an embodiment of the invention, a card connector includes a housing and a card tray configured to be drawn out of the housing. The card tray includes a first protrusion configured to define a movement path of the card tray, and a second protrusion configured to restrict a movement the card tray. The housing includes an inclined portion extending in a drawing direction of the card tray to guide the first protrusion.

The object and advantages of the invention will be realized and attained at least by the elements, features, and combinations particularly pointed out in the claims. It is to be understood that both the foregoing general description and the following detailed description are exemplary and explanatory, and are not restrictive of the invention.

### BRIEF DESCRIPTION OF DRAWINGS

FIGS. 1A to 1E illustrate an operation of a card connector according to an embodiment.

FIG. 2A is an exploded perspective view of the card connector according to the embodiment. FIG. 2B illustrates a portion of the card connector illustrated in FIG. 2A.

FIGS. 3A and 3B illustrate the configuration and operation of the card connector according to the embodiment.

FIG. 4 illustrates an exemplary card connector for use in an electronic device.

FIG. 5 illustrates an exemplary wiring board incorporating the card connector for use in an electronic device.

FIG. 6 is an exploded perspective view of a card connector according to the related art.

FIGS. 7A to 7C illustrate an operation of the card connector according to the related art.

### DESCRIPTION OF EMBODIMENTS

A card connector, a wiring board unit, and an electronic device according to the present invention will be described below with reference to accompanying drawings.

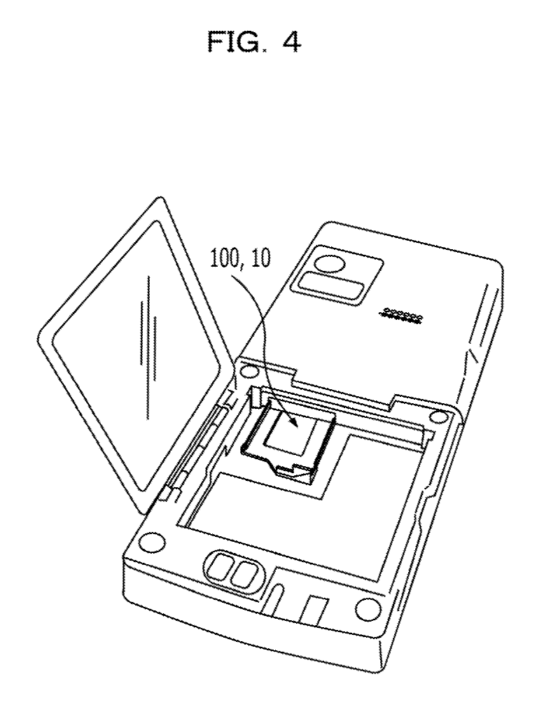

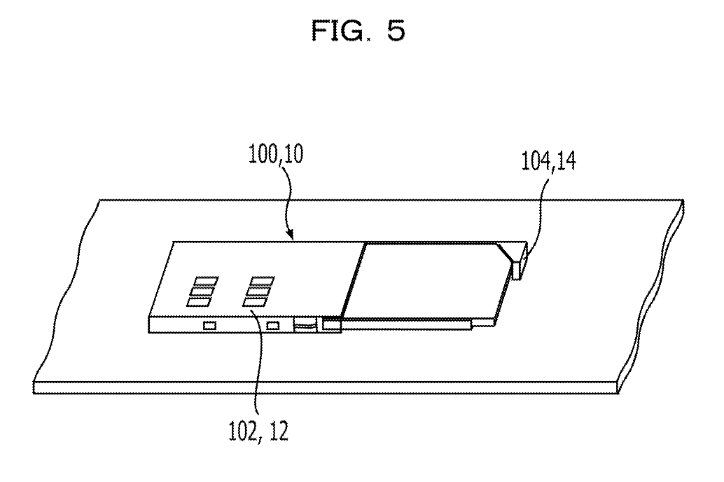

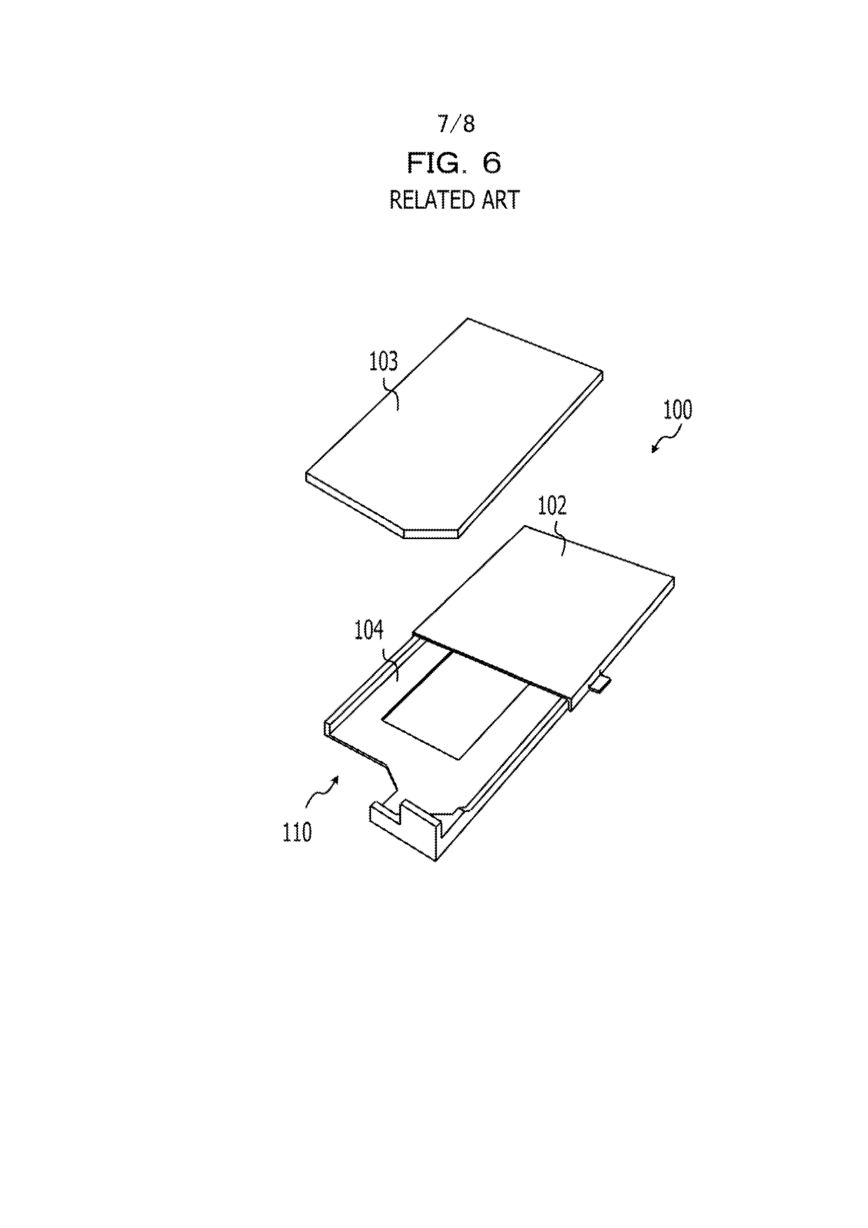

A card connector 10 according to an embodiment is a card connector that connects a SIM card for use in a cellular phone device to another electronic component in the cellular phone device as illustrated in FIG. 4, and is mounted on a wiring board as illustrated in FIG. 5.

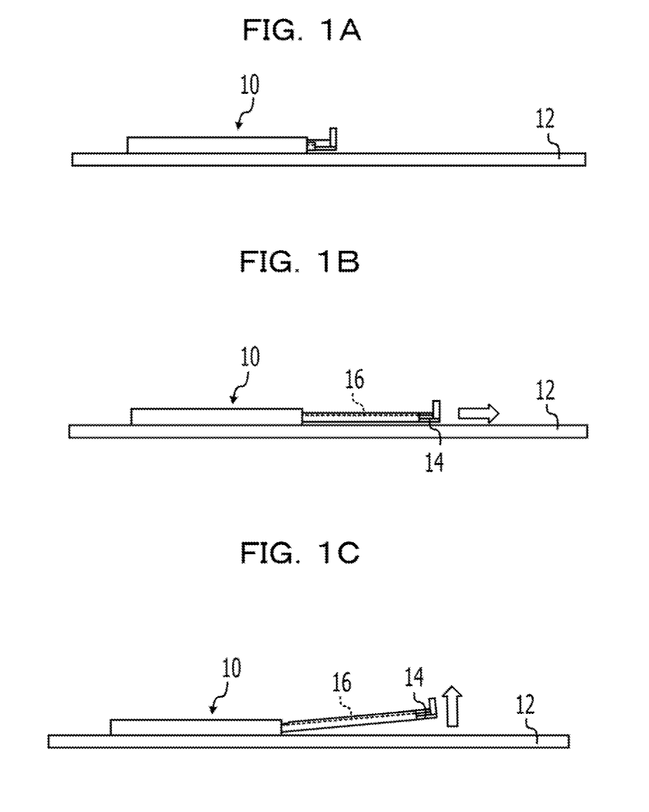

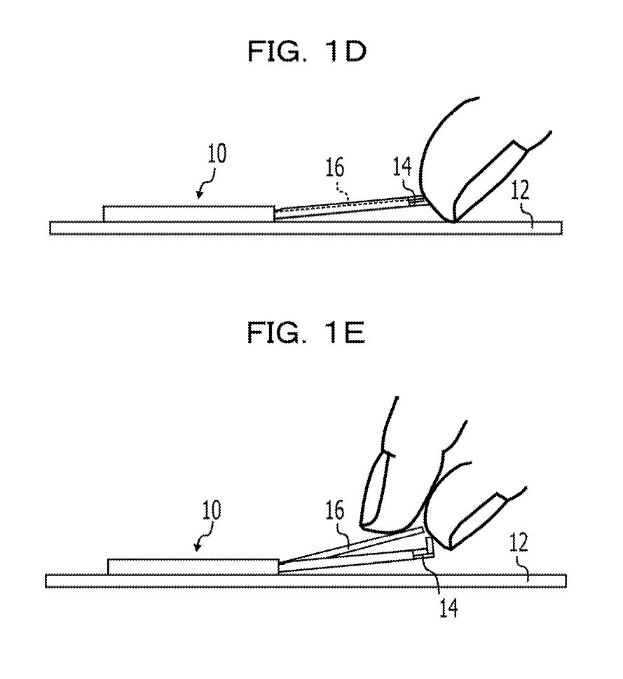

FIGS. 1A to 1E illustrate an operation of the card connector 10. From the card connector 10 mounted on a wiring board 12 illustrated in FIG. 1A, a tray 14 on which a SIM card 16 is mounted is drawn out in parallel with the wiring board 12 as illustrated in FIG. 1B. After the tray 14 is drawn out by a predetermined amount, the tray 14 is inclined such that the front end of the tray 14, which is on a side in the drawing direction, is lifted up with respect to the wiring board 12 as illustrated in FIG. 1C. Specifically, the tray 14 is inclined such that the front end of the tray 14 in the drawing direction is higher than the farther end of the tray 14, which is on a side in the opposite direction. When the tray 14 comes to a maximum drawn position, the tray 14 becomes stationary with inclination. Hereinafter, a side of the tray 14 in the drawing direction is referred to as a “front side”, and a farther side of the tray in the opposite direction is referred to as a “rear side”.

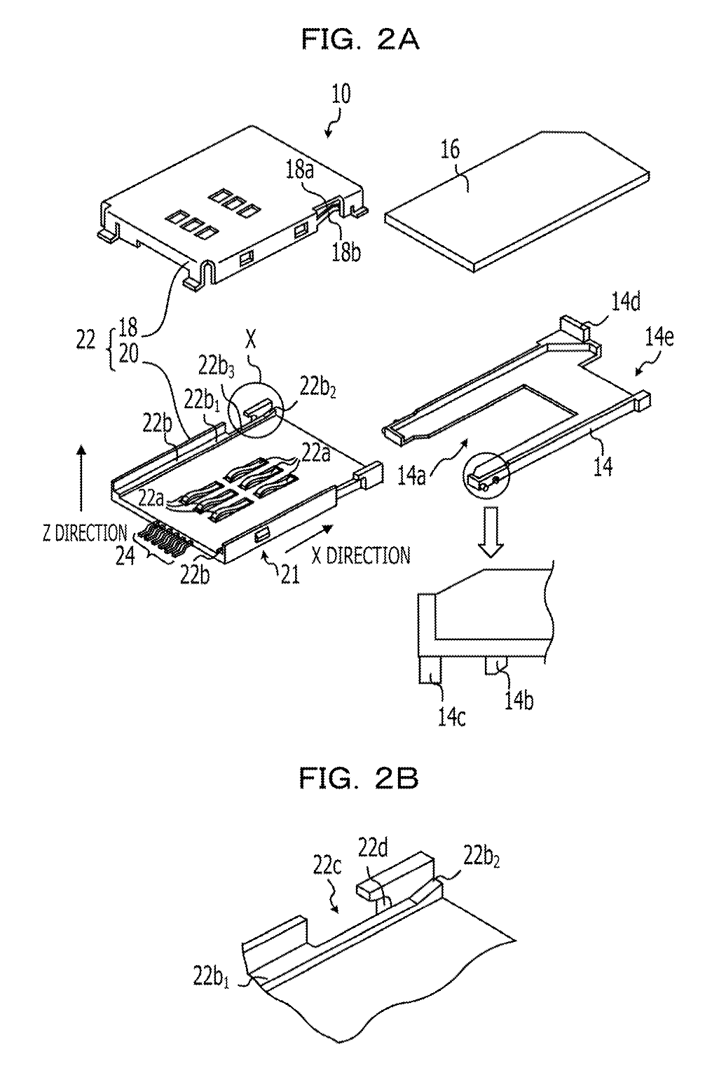

In this state, a user takes out the SIM card 16 mounted on the tray 14 as illustrated in FIG. 1E. At this time, the tray 14 is inclined, and therefore there is a relatively wide gap between the tray 14 and the wiring board 12. Thus, the SIM card 16 can be easily taken out by pinching the upper and lower surfaces of the SIM card 16 positioned at a notched portion 14e (see FIG. 2A) of the tray 14 with fingers.

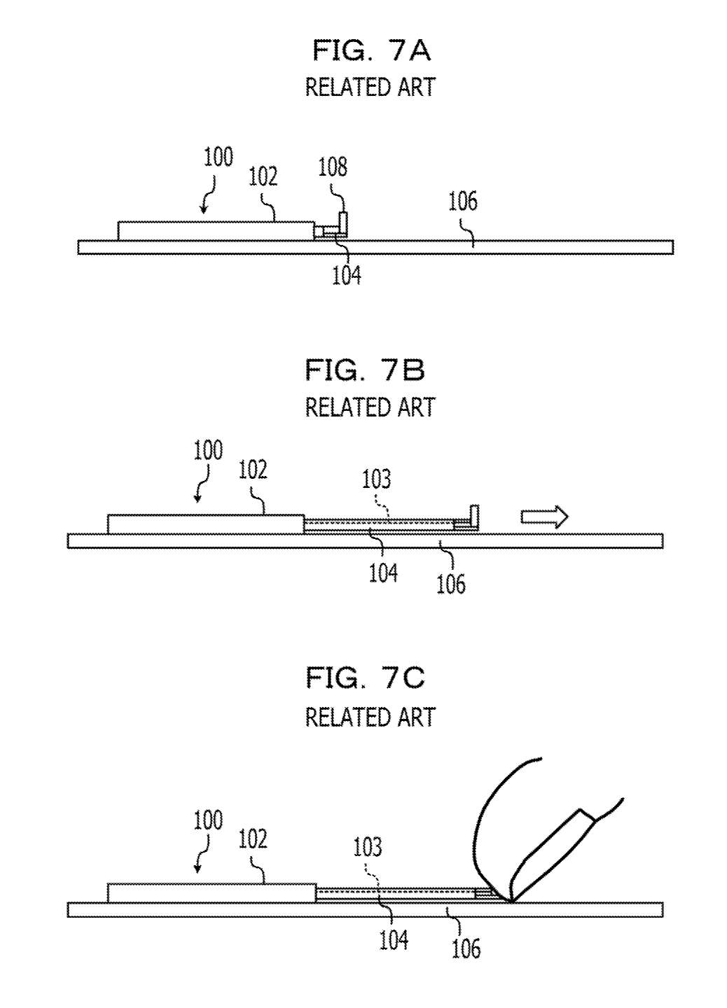

In this way, the card connector 10 allows the front end of the tray 14 in the drawing direction to be lifted up with respect to the wiring board 12 with the tray 14 at the maximum drawn position, unlike the card connector according to the related art illustrated in FIGS. 7A to 7C.

FIG. 2A is an exploded perspective view illustrating the configuration of the thus configured card connector 10. FIG. 2B illustrates a region X in FIG. 2A as enlarged.

The card connector 10 includes an upper housing 18, a lower housing 20, and the tray 14. The upper housing 18 and the lower housing 20 form a housing 22 that accommodates the tray 14.

The lower housing 20 includes a bottom surface 21 in contact with the wiring board 12. The bottom surface 21 is provided with six connection terminals 22a connected to an electronic component provided on the wiring board 12 or another wiring board through connection lines 24. The SIM card 16 is provided with six terminals. With the SIM card 16 mounted on the tray 14 to be accommodated at a predetermined position in the housing 22, the six terminals of the SIM card 16 are connected to the six connection terminals 22a of the lower housing 20. This allows the SIM card 16 to be connected to the electronic component.

A pair of guide racks 22b are provided on both inside surfaces of the lower housing 20 to extend in the X direction which corresponds to the drawing direction of the tray 14. A guide protrusion 14b provided on the tray 14 to be discussed later slides on the guide rack 22b.

A horizontal surface 22b₁ is provided on the rear side of the guide rack 22b. Meanwhile, an inclined surface 22b₂ is provided on the front side of the guide rack 22b. The inclined surface 22b₂ is formed by raising the surface of the guide rack 22b toward the front in the height direction (Z direction) which is orthogonal to the bottom surface 21 of the housing 22 and orthogonal to the X direction in which the horizontal surface 22b₁ extends. The guide protrusion 14b of the tray 14 to be discussed later passes on the horizontal surface 22b₁ and the inclined surface 22b₂ of the guide rack 22 when the tray 14 is drawn out. That is, the guide rack 22b serves as a drawing guide path that guides the guide protrusion 14b.

In the embodiment, the guide rack 22b on which the guide protrusion 14b slides is used as the drawing guide path. However, a slit-like groove for engagement with the guide protrusion 14b may be formed in the housing 22 to be used as the drawing guide path.

A notched portion 22c (see FIG. 2B) is provided in the side surface of the guide rack 22b of the lower housing 20 by notching a portion of the side surface. The notched portion 22c is positioned on the rear side with respect to the inclined surface 22b₂ in the X direction. In the notched portion 22c, a portion of the surface of the guide rack 22b is notched to narrow the width of the horizontal surface 22b₁ of the guide rack 22b, but only to such a degree that passage of the guide protrusion 14b to be discussed later is not hindered. A position restricting guide groove 22d is formed on the front side of the notched portion 22c to extend in parallel with the bottom surface 21 and the wiring board 12. The position restricting guide groove 22d is positioned in the side surface on the outer side of the guide rack 22b in the width direction of the tray 14 (which is orthogonal to the X direction and the Z direction). A stopper protrusion 14c to be discussed later enters the position restricting guide groove 22d when the tray 14 is drawn out. That is, the position restricting guide groove 22d is a groove extending in parallel with the horizontal surface 22b₁ with one end opening toward the notched portion 22c and with the other end closed. The groove width of the position restricting guide groove 22d is slightly wider than the projecting width of the stopper protrusion 14c so as to allow the stopper protrusion 14c to enter the position restricting guide groove 22d. However, the groove width of the position restricting guide groove 22d is determined such that the position restricting guide groove 22d restricts the position of the stopper protrusion 14c in the height direction (Z direction) when the stopper protrusion 14c enters the position restricting guide groove 22d. The closed end of the position restricting guide groove 22d functions as a terminal end that hinders the stopper protrusion 14c to be discussed later from advancing any further. The position of the tray 14 in this state corresponds to the maximum drawn position of the tray 14.

The upper housing 18 is a member that covers the lower housing 20. A notched portion 18a is provided in the side surface of the upper housing 18 at a position corresponding to the notched portion 22c of the lower housing 20. A long piece is provided in the notched portion 18a to project forward from the rear end of the notched portion 18a. The long piece is provided with a projecting portion 18b bent in a C-shape opening toward the inner side of the upper housing 18. The projecting portion 18b serves as a pressing member that presses the stopper protrusion 14c to be discussed later with the C-shaped bent portion.

The tray 14 is accommodated in the housing 22, which is formed by the upper housing 18 and the lower housing 20, with the SIM card 16 mounted on the tray 14. The tray 14 is provided with a notched portion 14a in the mounting surface for the SIM card 16 so that the SIM card 16 is connected to the connection terminals 22a provided on the lower housing 20 when the SIM card 16 is accommodated. The notched portion 14e is provided on the front side of the tray 14 to allow the SIM card 16 to be taken out by pinching the SIM card 16 with fingers.

The guide protrusion 14b and the stopper protrusion 14c are provided on the outer surface of both the side surfaces of the tray 14, which opposes the inner surface of the housing 22. The guide protrusion 14b is positioned at the same height as the stopper protrusion 14c in the Z direction (height direction). The stopper protrusion 14c is provided in the vicinity of an end of the tray 14 on the rear side of the tray 14 (on the farther side of the tray 14). The guide protrusion 14b is provided slightly on the front side with respect to the stopper protrusion 14c. The projecting height of the guide protrusion 14b is lower than that of the stopper protrusion 14c such that when the guide protrusion 14b moving on the guide rack 22b passes by the position restricting guide groove 22d, the guide protrusion 14b does not contact the closed end of the position restricting guide groove 22d to be hindered from moving. Further, the guide protrusion 14b has been chamfered on the side of the tray 14 in the drawing direction. This allows the guide protrusion 14b to smoothly move on the inclined surface 22b₂ when the guide protrusion 14b slides on the guide rack 22b.

A lug portion 14d is provided on the front side of the tray 14 to allow the user to draw out the tray 14 using his/her finger.

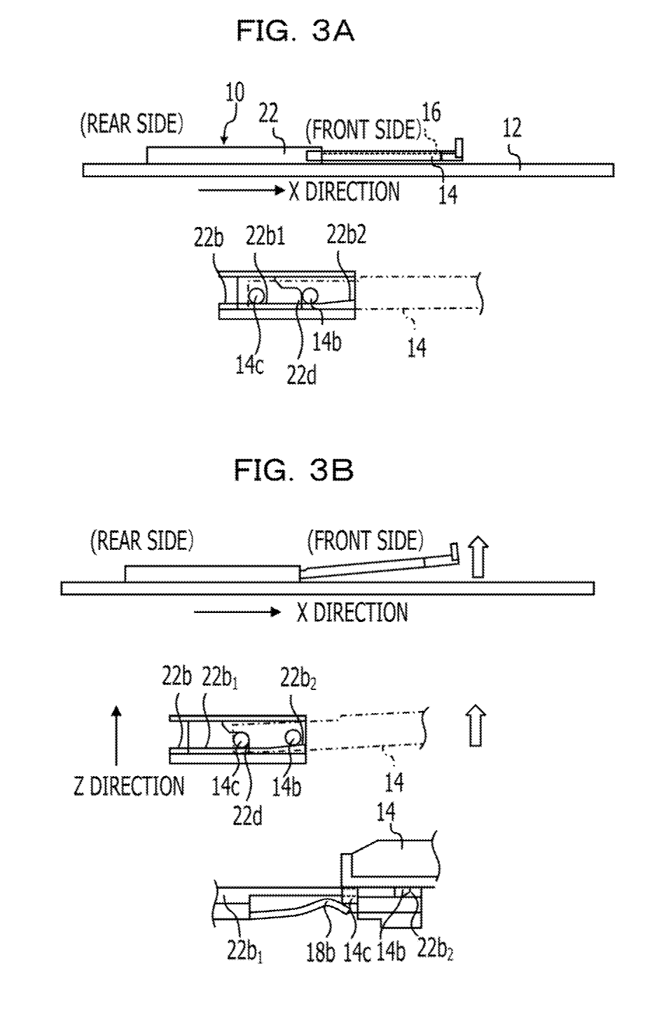

FIGS. 3A and 3B illustrate how the tray 14 is drawn out of the housing 22.

When the guide protrusion 14b is positioned on the horizontal surface 22b₁ as illustrated in FIG. 3A, the stopper protrusion 14c provided on the rear side of the tray 14 is also positioned on the horizontal surface 22b₁. Thus, the tray 14 is drawn out in parallel with the surface of the wiring board 12.

When the tray 14 is further drawn out of the housing 22, the guide protrusion 14b passes by the position restricting guide groove 22d to move on the inclined surface 22b₂ as illustrated in FIG. 3B. As discussed above, the projecting height of the guide protrusion 14b is lower than that of the stopper protrusion 14c. Thus, the guide protrusion 14b passes without being hindered from moving by the position restricting guide groove 22d. When the guide protrusion 14b moves on the inclined surface 22b₂, the stopper protrusion 14c provided on the rear side on the tray 14 still moves on the horizontal surface 22b₁. Since the stopper protrusion 14c enters the position restricting guide groove 22d so that movement of the stopper protrusion 14c in the Z direction (height direction) is restricted, the stopper protrusion 14c is not lifted up in the height direction. Thus, the guide protrusion 14b and the stopper protrusion 14c are displaced from each other in the Z direction (height direction) to cause inclination such that the front side of the tray 14 is positioned to be higher.

In the embodiment, the guide protrusion 14b and the stopper protrusion 14c are provided at the same position in the Z direction (height direction). However, they may be provided at different positions in the Z direction (height direction). In this case, only the guide protrusion 14 may move on the guide rack 22b. In this case, the position restricting guide groove 22d is preferably provided in accordance with the position of the stopper protrusion 14c in the Z direction (height direction).

The stopper protrusion 14c further moves until it contacts the terminal end of the position restricting guide groove 22d. When the stopper protrusion 14c contacts the terminal end of the position restricting guide groove 22d, the tray 14 has been drawn to the maximum drawn position. At this time, the stopper protrusion 14c provided in the vicinity of the rear end of the tray 14 is still positioned on the horizontal surface 22b₁, and movement of the stopper protrusion 14c in the height direction (Z direction) is restricted. Therefore, at the maximum drawn position, the tray 14 is maintained in an inclined state in which the front side of the tray 14 is positioned to be high.

At this time, the stopper protrusion 14c has passed through a pressing portion of the projecting portion 18b of the upper housing 18, which is formed in a C-shape to function as the pressing member, to be positioned between the projecting portion 18b and the terminal end of the position restricting guide groove 22d. The pressing member having a C-shape is a flat plate spring. When the stopper protrusion 14c contacts the terminal end of the position restricting guide groove 22d, the stopper protrusion 14c is urged forward in the X direction by the pressing portion of the projecting portion 18b functioning as the pressing member at the same time. Thus, the stopper protrusion 14c is engaged between the projecting portion 18b and the terminal end of the position restricting guide groove 22d. Therefore, the tray 14 is stationary with inclination with respect to the wiring board 12 at the maximum drawn position.

As has been described above, when the tray 14 is drawn out to approach the maximum drawn position, the guide protrusion 14b moves on the inclined surface 22b₂. At this time, the stopper protrusion 14c is positioned in the position restricting guide groove 22d, which keeps the position of the stopper protrusion 14c in the height direction constant. Thus, the tray 14 is inclined with the front side of the tray 14 lifted up as illustrated in FIG. 1.

In the embodiment, the SIM card is to be accommodated. However, any card-like electronic module other than the SIM card may also be used. Examples of the electronic module include a memory card, such as a smart media.

All examples and conditional language recited herein are intended for pedagogical objects to aid the reader in understanding the invention and the concepts contributed by the inventors to further the art, and are to be construed as being without limitation to such specifically recited examples and conditions, nor does the organization of such examples in the specification relate to a showing of the superiority or inferiority of embodiments of the invention. Although the embodiments of the invention have been described in detail, it will be understood by those of ordinary skill in the relevant art that various changes, substitutions, and alterations could be made hereto without departing from the spirit and scope of the invention as set forth in the claims.

What is claimed is:

1. A card connector comprising:
a housing; and
a card tray configured to be drawn out of the housing, the card tray includes
a first protrusion configured to define a movement path of the card tray and
a second protrusion configured to restrict a movement the card tray,
wherein the housing includes an inclined portion extending in a drawing direction of the card tray to guide the first protrusion.

2. The card connector according to claim 1, wherein the inclined portion is configured to displace the first protrusion from a bottom surface of the housing in a height direction.

3. The card connector according to claim 1, wherein the housing further includes a slit configured to engage the second protrusion to restrict a movement of the second protrusion.

4. The card connector according to claim 3, wherein the slit is a groove with one end open and the other end closed through which the second protrusion passes when the first protrusion moves on the inclined portion.

5. The card connector according to claim 1, wherein the inclined portion includes a surface on which the first protrusion slides.

6. The card connector according to claim 1, wherein the second protrusion is provided on a farther side of the card tray with respect to the first protrusion.

7. The card connector according to claim 1, wherein the first protrusion has a smaller height from a side surface of the card tray than the second protrusion.

8. The card connector according to claim 3, wherein the slit includes a pressing member configured to press the second protrusion engaged with the slit.

9. The card connector according to claim 8, wherein the pressing member is a flat plate spring having a C-shape configured to open toward the inclined portion.

10. A wiring board unit comprising:
a wiring board; and
a card connector mounted on the wiring board and electrically connected to the wiring board, the card connector including
a housing and
a card tray configured to be drawn out of the housing, wherein the card tray includes
a first protrusion configured to define a movement path of the card tray and
a second protrusion configured to restrict a movement the card tray, and
wherein the housing includes an inclined portion extending in a drawing direction of the card tray to guide the first protrusion.

11. The wiring board unit according to claim 10, wherein the inclined portion is configured to displace the first protrusion from a bottom surface of the housing in a height direction.

12. The wiring board unit according to claim 10, wherein the housing further includes a slit configured to engage the second protrusion to restrict a movement of the second protrusion.

13. The wiring board unit according to claim 12, wherein the housing further includes a slit configured to engage the second protrusion to restrict a movement of the second protrusion.

14. The wiring board unit according to claim 10, wherein the inclined portion includes a surface on which the first protrusion slides.

15. The wiring board unit according to claim 10, wherein the second protrusion is provided on a farther side of the card tray with respect to the first protrusion.

16. The wiring board unit according to claim 10, wherein the first protrusion has a smaller height from a side surface of the card tray than the second protrusion.

17. The wiring board unit according to claim 12, wherein the slit includes a pressing member configured to press the second protrusion engaged with the slit.

18. The wiring board unit according to claim 17, wherein the pressing member is a flat plate spring having a C-shape configured to open toward the inclined portion.

19. An electronic device comprising:
an enclosure;
a wiring board installed in the enclosure; and
a card connector mounted on the wiring board and electrically connected to the wiring board, the card connector including
a housing and
a card tray configured to be drawn out of the housing, wherein the card tray includes
a first protrusion configured to define a movement path of the card tray and
a second protrusion configured to restrict a movement the card tray, and
wherein the housing includes an inclined portion extending in a drawing direction of the card tray to guide the first protrusion.
